(19) United States
(12) Patent Application Publication
(10) Pub. No.: US 2026/0044722 A1
(43) Pub. Date: Feb. 12, 2026

(54) SEQUENTIAL NEURAL MACHINE FOR MEMORY OPTIMIZED INFERENCE

(71) Applicant: INNATERA NANOSYSTEMS B.V., Rijswijk (NL)

(72) Inventors: Subhajit PAUL, The Hague (NL); Ayon BORTHAKUR, Delft (NL)

(21) Appl. No.: 19/102,428

(22) PCT Filed: Aug. 16, 2023
(86) PCT No.: PCT/EP2023/072594

§ 371 Date: Feb. 10, 2025

Related U.S. Application Data
(60) Provisional application No. 63/398,244, filed on Aug. 16, 2022.

(51) Int. Cl. G06N 3/063

(52) U.S. Cl. CPC G06N 3/063

(57) ABSTRACT

A spiking neural processor configured to receive one or more input signals and generate one or more inference output signals. The spiking neural processor comprises a plurality of neurons interconnected by a plurality of synaptic elements to form a spiking neural network. A portion of the neurons are connected to receive the input signals and each of the neurons is configured to generate a neuron output signal. The spiking neural processor also comprises a storage unit connected to receive one or more of the neuron output signals from a selected subset of the neurons, and one or more augmented input circuits connected by the synaptic elements to selected ones of the neurons. The storage unit is configured to store data indicative of the received neuron output signals, and output at least a portion of the stored data after a predetermined delay. The augmented input circuits are connected to receive the stored data outputted by the storage unit after the predetermined delay.

### TECHNICAL FIELD

This disclosure generally relates to spiking neural processors, and more particularly to systems and methods for storing and recalling neural network state information in a spiking neural processor.

### BACKGROUND

Spiking neural processors (SNP) are signal processing systems whose design is inspired by biological neural networks. Information is encoded in patterns of spike signals distributed across a network of neurons and synapses. SNPs can perform signal processing for multiple types of sensors and applications, such as image recognition, sound recognition, detection of events based on input from multiple sensors, etc.

Analog neurons utilize analog memory elements, such as capacitors, to accumulate spikes and retain temporal neural network state information between spikes. To achieve acceptable latency of the SNP, reduce costs driven by chip area and reduce power consumption, these components are designed such that they can retain the state information only over a short time window, typically in the order of a few hundreds of microseconds. As a result, the network state information leaks away over time, e.g. due to leakage of the accumulated electrical charge from the capacitor of a neuron, thereby returning the network to a neutral state.

On the other hand, real-world digital sensors sample analog variables at a certain rate and quantize the sampled values. The quantized data values are generated and forwarded to the next stage of processing periodically. Examples are audio processing engines, RADAR sensors, etc. The interval between output of the sensor data values, for example in the order of milliseconds or tens of milliseconds, can be interval of data collection can be orders of magnitude larger than the ability of the neurons of an SNP to maintain their charge. A problem arises in how to interface an SNP with such sensors where the SNP cannot retain neural network state information in the time period between receipt of sensor data values.

One way of retaining the neural network state information is using large memory buffers in which the network state information is stored during these periods. However, this incurs a significant cost in increased chip area and higher power consumption. It is also prohibitive for streaming and continuous inference operations as the finite buffer size imposes a limitation on what the maximum size of the inference window can be.

### SUMMARY OF INVENTION

The invention provides a means to address the problems described above, by providing an efficient means to record neural network state information and provide the recorded state information for use during neural network operation.

In one aspect, the invention provides a spiking neural processor configured to receive one or more input signals and generate one or more inference output signals. The spiking neural processor comprises a plurality of neurons interconnected by a plurality of synaptic elements to form a spiking neural network (SNN). A portion of the neurons are connected to receive the input signals and each of the neurons is configured to generate a neuron output signal. The spiking neural processor also comprises a storage unit connected to receive one or more of the neuron output signals from a selected subset of the neurons, and also comprises one or more augmented input circuits connected by the synaptic elements to selected ones of the neurons. The storage unit is configured to store data indicative of the received neuron output signals, and output at least a portion of the stored data after a predetermined delay. The augmented input circuits are connected to receive the stored data outputted by the storage unit after the predetermined delay.

The neuron output signals from the selected subset of the neurons are stored in the storage unit as a means of recording information embodying at least a portion of the neural network state during the period when the SNN is active and neuron output signals from the selected subset of neurons are recorded. Thus, the storage unit may be configured to store the data indicative of the received neuron output signals during a period when the input signals are received by the spiking neural network. In addition, the storage unit may be configured to not store the data during a period when no input signals are received by the spiking neural network. This corresponds to a period of inactivity of the SNN and the storage unit retains the previously recorded data during this period but does not record new data to conserve memory.

The storage unit may be configured to output at least a portion the stored data during a subsequent period when the input signals are received by the spiking neural network. Thus, when the SNN receives another burst of input signals, the previously recorded data indicative of the neural network state during the previous period of network activity is outputted by the storage unit and received by the augmented input circuits. This provides feedback of the previous network state information to recreate the “context” of the previous period of SNN activity. In addition, the storage unit may be configured to not output the stored data during a period when no input signals are received by the spiking neural network.

The data outputted by the storage unit during the subsequent period may comprise at least a portion the data stored during an immediately preceding period when the input signals were received by the spiking neural network. The storage unit may be configured to store data encoding a spike time, a spike amplitude, and/or a spiking rate of the neuron output signals from the selected subset of the neurons.

The operation of the storage unit may be coordinated with an input buffer circuit, so that the storage unit records the data indicative of the received neuron output signals during a burst period when the input buffer circuit forwards the input signals to the spiking neural network, and does not record the data during a period when the input buffer does not forward the input signals to the spiking neural network.

The spiking neural processor may further comprise an input buffer circuit connected to receive one or more signals from an input signal source, wherein the input buffer circuit is configured to accumulate the received signals for a buffering period and output the accumulated signals during a burst period as the input signals to the spiking neural network.

The buffering period of the input buffer circuit may be coordinated with the predetermined delay of the storage unit. The storage unit may be configured to output the stored data during a period when the input buffer circuit outputs the accumulated signals to the spiking neural network. The burst period may be at least 10 times shorter than the buffering period, the input buffer circuit being configured to output the accumulated signals at a compressed time scale in comparison to the signals received from the input signal source.

In another aspect, a method of operating a spiking neural processor is provided, for a spiking neural network configured to receive one or more input signals and generate one or more inference output signals, the spiking neural processor comprising a plurality of neurons interconnected by a plurality of synaptic elements to form a spiking neural network, each of the neurons is configured to generate a neuron output signal. The method comprises connecting one or more augmented input circuits by the synaptic elements to selected ones of the neurons of the spiking neural network; receiving the one or more input signals by a portion of the neurons; receiving one or more of the neuron output signals from a selected subset of the neurons by a storage unit; storing data indicative of the received neuron output signals in the storage unit; outputting from the storage unit at least a portion of the stored data after a predetermined delay; and receiving by the augmented input circuits the stored data outputted by the storage unit after the predetermined delay.

The storing of the data indicative of the received neuron output signals may be performed during a period when the input signals are received by the spiking neural network. The outputting from the storage unit of at least a portion of the stored data may be performed during a subsequent period when the input signals are received by the spiking neural network.

The method may further comprise coordinating the operation of the storage unit with an input buffer circuit, so that the storage unit stores the data indicative of the received neuron output signals during a burst period when the input buffer circuit forwards the input signals to the spiking neural network, and does not record the data during a period when the input buffer does not forward the input signals to the spiking neural network.

The method may further comprise connecting an input buffer circuit to receive one or more signals from an input signal source, accumulating the received signals for a buffering period, and outputting the accumulated signals during a burst period as the input signals to the spiking neural network.

### BRIEF DESCRIPTION OF THE DRAWINGS

Embodiments will now be described, by way of example only, with reference to the accompanying drawings in which corresponding reference symbols indicate corresponding parts, and in which:

FIG. 1 is a schematic diagram of a simple spiking neural processor;

FIG. 2 is a schematic diagram of a neurons and synaptic elements implemented using a crossbar design;

FIG. 3 is a schematic diagram of the spiking neural processor of FIG. 1 also including a storage unit and augmented input circuits;

FIG. 4 is a timing diagram showing an example of signal timelines in the spiking neural processor of FIG. 3; and

FIG. 5 shows simulated test results for a spiking neural processor.

### DESCRIPTION OF EMBODIMENTS

In the following description, certain illustrative embodiments have been illustrated and described. As those skilled in the art would realize, these embodiments may be modified in various different ways without departing from the scope of the present disclosure. Accordingly, the drawings and description are to be regarded as illustrative in nature and not restrictive. Like reference numerals designate like elements in the specification.

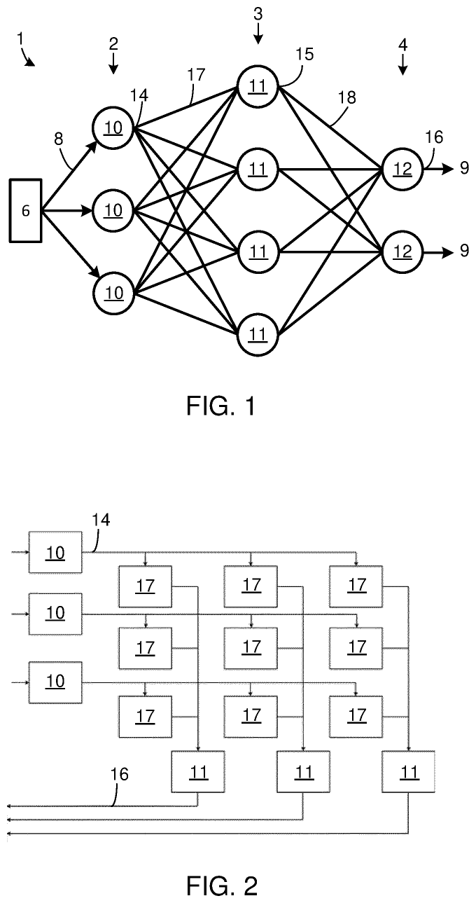

FIG. 1 is a schematic diagram of a simple spiking neural processor 1 comprising a spiking neural network (SNN). The SNN in this example comprises an input layer 2 of neurons 10 (input neurons), a hidden layer 3 of neurons 11 (hidden neurons), and an output layer 4 of neurons 12 (output neurons). The input neurons are connected via synaptic elements 17 to hidden neurons 11, and the hidden neurons 11 are connected via synaptic elements 18 to output neurons 12. The output 9 of the overall system is generated by the last layer of output neurons 12 in the SNN. The output 9 of the output neurons 12 is then passed to a decoding layer which can pass the information forward for further processing or output to the user.

The spiking neural processor shown in FIG. 1 is illustrated with only three layers having very few neurons and synaptic elements for simplicity, but a practical processor may have a very large number of layers, neurons and synaptic elements to achieve satisfactory performance. A practical implementation of a spiking neural processor typically comprises hundreds of thousands or millions of neurons, and a correspondingly large number of synapses. The spiking neural processor may be implemented using hardware circuits or a combination of hardware and software or firmware, and may be implemented as a single integrated circuit and may be implemented as an embedded system. The neurons may be implemented using analog or digital circuits, or mixed signal circuits.

The input neurons 10 receive input signals from a signal source 6, such as a sensor, and generate neuron output signals 14 in the form of a train of spikes. The neurons 11, 12 in subsequent layers 3, 4 receive the output signals generated by synapses 17, 18 and generate neuron output signals 15, 16 in the form of a train of spikes. Each neuron 11, 12 receives a synapse output signal from one or more of the synapses 17, 18, depending on the configured synaptic connections. For example, every neuron in one layer may be connected via synapses to every neuron in the following layer as shown in FIG. 1, or the network may be configured to make selective connections via the synapse between selected neurons of adjacent layers. Many different connectivities between neurons may be used in addition to those described, and may also include skip connections, highly recurrent liquid state machine architectures, etc.

Each neuron 10, 11, 12 accumulates or integrates the received signals (input signals or synapse output signals) and generates a neuron output signal 14, 15, 16. The neurons generate spikes at their outputs as a function of the received input signals and its current state

The neuron output signal will include a spike when the integrated value (referred to as the membrane potential) reaches a predetermined threshold value. In an analog implementation of a neuron, the integrated value of the received signals may be stored as electrical charge stored on a capacitor.

When the threshold is reached, the neuron fires, generating a spike (i.e. a voltage or current spike) at the neuron's output. At the time of firing, the membrane potential is reduced as a result of the firing. If the membrane potential subsequently again reaches the threshold value, the neuron will fire again, generating a second spike. Each neuron is thus configured to generate a neuron output signal 14, 15, 16 in the form of a spatio-temporal spike train. The neuron output signal 14, 15, 16 depends on several parameters of the neuron, such as the input gain, integration constant and threshold value. The membrane potential of each neuron also “leaks”, the potential gradually reducing over time if no input signals are received to cause the potential to increase.

Each synaptic element 17, 18 (also referred to a synapse) receive an output signal from one of the input circuits 10 or neurons 11. The synapses 17, 18 amplify or attenuate the received output signal by a predetermined factor determined by their weight setting, which is configurable. The weight of a synapse may be positive so that a synaptic output signal received from that synapse excites the neurons which receive the signal, raising their membrane potentials. The weight may be negative, which inhibits the neurons which receive a synaptic output from that synapse, potentially lowering their membrane potentials. Or the weight may be zero, which effectively removes the synaptic connection between the two neurons connected via the synapse. The weight for each synapse is stored in a memory cell associated with the synapse. The values of all the weights in the network is known as the weight matrix, the weights typically determined by the network training process.

FIG. 2 is a simplified schematic diagram of synapse connections implemented as a crossbar array. A crossbar design is an efficient way of implementing a reconfigurable neural network, especially when manufactured on an integrated circuit. The design in FIG. 2 includes a rectangular array of synapses 17 used to interconnect two layers of the SNN, e.g. synapses 17 connecting neurons 10 on one side of the array to neurons 11 on another side, or synapses 18 connecting neurons 11 on one side of the array to neurons 12 on another side. In the embodiment in FIG. 2, neurons 10 are arranged in one column, each driving a row of synapses 17. The synapses 17 are connected in columns, with the outputs of all synapses 17 in a column added together and serving as the input to a neuron 11. By programming appropriate weights in the synapse array and correctly configuring the interconnect system, a wide variety of network topologies can be implemented.

In the spiking neural processor of FIG. 1, the input layer neurons 10 receive input signals 8 from an input signal source 6, such as a sensor. Many such input signal sources 6 generate data at a relatively slow rate or in bursts with long periods between the bursts. For example, a microphone may generate an analog output signal which is sampled at a certain frequency. The samples may then be converted to digital data by an analog-to-digital converter (ADC) or converted to a spike train output. This may be implemented, for example, using multiple outputs, each output transmitting a spike when the sampled value falls within a certain value range for that output. If a sampling rate of 1 kHz is used, for example, a digital output value or corresponding spike outputs will be produced every millisecond.

Other types of input signal sources 6 may generate output data at a fast rate but intermittently, for example due to the nature of the variable or phenomena being measured or sampled, or the functioning of the signal source.

The SNP 1 operates at a much faster rate than many input signal sources, and the neurons in the neural processor will forget their previous state, i.e. their membrane potential may revert to zero or a low value due to leakage, during the interval between the receipt of input signals from the input signal source 6. This loss of neural network state information may occur in a very short time period, for example in a fraction of a millisecond.

Although the neurons could be designed to retain their membrane potential for a longer time period, this would slow down the operation of the neurons and increase latency of the SNP, would increase the size of the neurons resulting in a large increase in chip area and manufacturing cost of the SNP, and would increase power consumption of the SNP.

Alternatively, a memory could be used to store the membrane potentials of the neurons during periods of inactivity. However, a large memory would be required which would likewise result in increased chip area and manufacturing cost and higher power consumption, and the size of the memory would be a constraint on the operation of the SNP for many applications.

The SNP may address this problem by implementing a “forget-and-remember” strategy. Imagine you are reading a book and stop reading at page 39 of the book, and place a bookmark on that page. You resume reading after a week and do not remember all the details of the first 39 pages. So you read the last few lines of the bookmarked page to remember the context, and then you can continue reading from page 40. The “forget-and-remember” strategy is a similar strategy. The neurons of the SNN forget the temporal network state information when there is a long period with no input signals, e.g. due to inactivity or low data rate of the input signal source. But a portion of the neuron output signals generated during the last period when input signals were received and the SNN was active, may be recorded and stored in a memory. This stored data may then be replayed at a later period of activity of the SNN, to enable the SNN to “remember” a part of the network state information which existed during the previous period of activity, to improve the inferencing accuracy of the SNP.

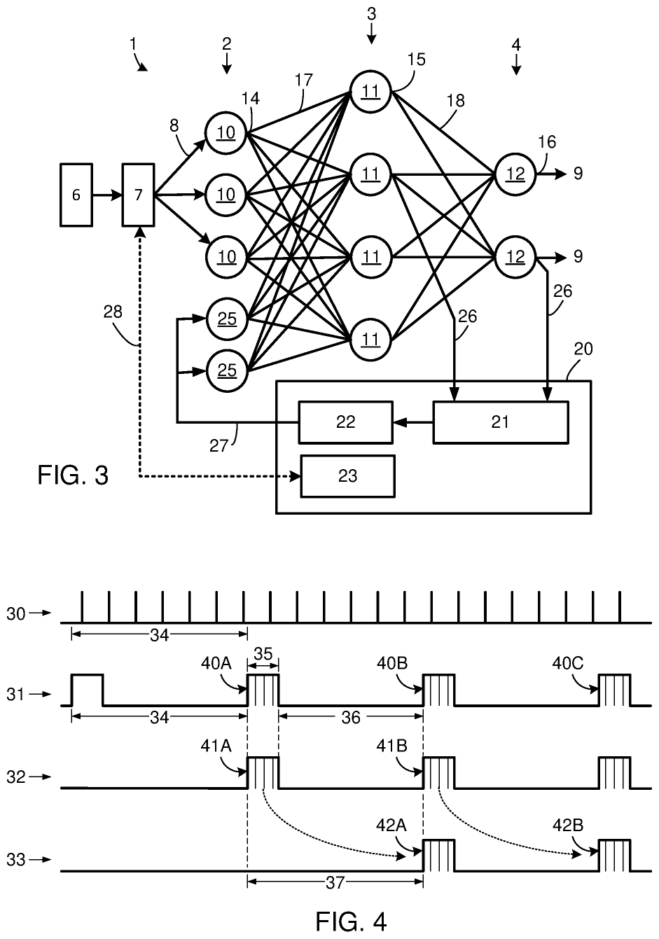

FIG. 3 shows a schematic diagram of the spiking neural processor of FIG. 1 with the addition of a storage unit 20 and augmented input circuits 25. The augmented input circuits 25 are connected via additional synapses to neurons of the SNP. For example, in the embodiment show in FIG. 3 the augmented input circuits 25 are connected via additional synapses 17 to the neurons 11 in layer 3 of the neural network, i.e. the same layer of neurons which receive signals via synapses 17 from the input layer neurons 10. However, other configurations are possible so that the augmented input circuits 25 may be connected via synapses to any of the neurons in the SNP. The number of augmented input circuits 25 may be configurable and the synaptic connections of the augmented input circuits 25 to neurons may be configurable, for example these being configured following training of the neural processor.

The augmented input circuits 25 may be neurons like the input layer neurons 10 which generate a spike at their output as a function of the received input signals and their current state, or may be simple pass-through circuits passing a received input signal to its output, or other type of circuit suitable for receiving input from the storage unit 20 and providing an output to the synapses. The augmented input circuits 25 can be treated the same as the neurons 10 of the input layer 2, and may be configured with synapse connections to other neurons in the network in the same way as the neurons 10, e.g. fully connected via synapses 17 to the every neuron 11 in the next layer 3 of the SNN, or with sparse connections to other neurons.

The number of augmented input circuits 25 is configurable by a network hyperparameter, i.e. a parameter whose value is used to control the learning process of the network during training, in most cases with a fixed value throughout a training process.

The storage unit 20 includes a memory 21, delay circuit 22, and control unit 23. The storage unit 20 receives neuron output signals from a selected subset of the neurons of the SNN, referred to herein as “memory-neurons”. The output spikes from these memory-neurons are used as a means of recording the recent spike history of the SNN by recording the memory-neuron outputs in storage unit 20. This provides a means to store information about the recent neural network state, obtained during a recent period of activity of the SNN resulting from the receipt of input signals by the SNN. By storing this neural network state information in storage unit 20, the state information can be preserved for a prolonged period, for example during a period of inactivity when the SNN does not receive any input signals resulting in the neurons in the SNN losing their membrane potential due to leakage.

For example, the SNN may be configured so that storage unit 20 receives neuron output signals from all of the output neurons 12, e.g. all of the neurons in the last layer of the SNN. Other approaches may be used to select specific neurons from any layers of the SNN for proving neuron outputs to the storage unit 20. For example, the neurons which demonstrate more dynamics may be identified and selected for memory-neuron candidates, e.g. neurons whose weights are updated more frequently than others during training, or neurons which exhibit a wider range of spiking patterns during inference. In the example shown in FIG. 3, the storage unit receives neuron output signals from a neuron in layer 3 and a neuron in layer 4. The number of neurons selected to serve as memory-neurons may be equal to the number of augmented input circuits 25, or may be different.

The storage unit 20 is configured to record and store the memory-neuron output signals 26 in the memory 21 under control of the control unit 23, during the periods when input signals 8 are received by the SNP. For example, the input neurons 10 may receive input signals 8 in short bursts from input signal source 6 or input buffer 7, with longer intervening periods of inactivity during which no input signals 8 are received. The control unit 23 is configured to coordinate the recording and storage of the memory-neuron outputs 26 with the bursts of input signals received by the input neurons 10 of the SNP. The control unit 23 may initiate recording and storing the memory-neuron outputs 26 during the short bursts when the SNP is receiving input signals 8, and may stop the recording of the memory-neuron outputs 26 (to reduce the amount of storage capacity required) during the intervening periods of inactivity during which no input signals 8 are received by the SNP (while maintaining in memory 21 the data previously recorded during the last burst of input signals 8). This coordination may be implemented by communication between the control unit 23 and an input buffer 7, as described further below.

The storage unit 20 is configured to store data indicative of the received memory-neuron output signals 26 in the memory 21. For example, the storage unit 20 may store data regarding one or more parameters of any spikes in the memory-neuron output signals 26. The amount of information for each recorded spike is configurable, for example the storage unit 20 may store data regarding the time when spikes occur, the amplitude of the spikes, and/or rate of spiking of the neuron output signals. In one embodiment, the storage unit 20 is configured to store data for each spike generated by each of the memory-neurons, i.e. any spike on the inputs 26 to the storage unit 20. For example, the storage unit 20 may record the identity of the neuron generating a spike and a time value indicating when the spike occurred. This data is preferably encoded to permit efficient storage of the data and reduce required size of the memory 21. For example, the storage unit 20 may record a neuron ID and a relative time for each spike, where the relative time indicates a time difference from the start of a burst of data received by the SNN and the time when the spike occurred. By efficiently encoding the spike data received by the storage unit 20, the SNP can record neural network state information in an efficient manner while keeping the size of the memory 21 in storage unit 20 to a minimum.

The storage unit 20 is configured to output previously stored data during periods when input signals 8 are received by the input neurons 10. In this way, storage unit 20 provides the previously recorded neural network state information to the augmented input circuits 25 during the period when the input neurons 10 of the SNN are receiving further input signals. This enables the neural network to incorporate the previous state information into the inference processing of currently received input signals.

For example, the control unit 23 may be configured to control the storage unit 20 to output stored data during a burst of input signals 8 received by the SNP, where the data comprises at least a portion of the data stored during the immediately preceding burst of input signals 8 received by the SNP. During a current burst of input signals 8, the storage unit 20 may output all of the data recorded and stored during the previous burst of input signals, or only a portion of that data.

The augmented input circuits 25 are connected to receive the output from storage unit 20. The augmented input circuits 25 receive the stored data output from storage unit 20, but may additionally receive inputs signals 8, e.g. from the input buffer 7, and/or inputs from input neurons 10. The augmented input circuits 25 may be configured to generate spikes at their outputs as a function of the received input signals and their current state. The SNP may be configured to adapt the number of augmented input circuit 25 to the number of memory-neurons whose neuron outputs 26 are recorded by the storage unit 20. In one embodiment, each augmented input circuit 25 receives stored data of spikes generated by one of the memory-neurons. For example, each augmented input circuit 25 may be connected to receive stored data (from the storage unit 20) derived from a particular one of the memory-neurons. Alternatively, the augmented input circuits 25 may receive stored data of spikes generated by more than one memory-neuron, or stored data of spikes generated by more than one memory-neuron may be received by a single augmented input circuit 25.

The previously recorded data may be output by the storage unit 20 in a manner to preserve the timing of the spikes recorded during the previous burst of input signals 8. For example, the relative timing of a spike within an input signal burst may be preserved so that it is “replayed” at the same relative timing during the current input signal burst. This enables the augmented input circuits 25 to generate output spikes at the same timing within the current input signal burst to recreate the timing of the spikes generated by the memory-neurons during the previous input signal burst.

Alternatively, the storage unit 20 may transform the stored data. For example, the spike timing may be reversed, e.g. so that the last spike recorded during a previous input signal burst is outputted first during the current input signal burst and so forth. This may be implemented for example, where the last spikes generated by output neurons are considered most significant for recreating the neural network state during the previous input signal burst.

The storage unit 20 includes memory 21 which may be a digital memory such as a DRAM, SRAM, or register memory. A shift register may be used, e.g. a FIFO (first-in first-out) shift register to preserve spike timing or a LIFO (last-in first-out) shift register to reverse spike timing. The storage unit 20 also includes a delay circuit 22. This may be a separate memory, or logic circuits controlling the output from memory 21, or may be included as part of memory 21 (e.g. where memory 21 is a shift register). The delay circuit 22 (in conjunction with the control unit 23) implements a predetermined delay in the output of data from storage unit 20. This predetermined delay is selected to time the output of stored data from storage unit 20 to coincide with a current input signal burst, or precede it, as described further below. The storage unit 20 also include a control unit 23, which controls the operation of the storage unit 20. Control unit 20 may be implemented as hardware logic circuits such as an ASIC or FPGA, or a processor executing software or firmware, or combination of these.

FIG. 3 also shows an optional input buffer 7, which may be used to buffer the signals generated by signal source 6 and output the accumulated input signals 8 to the input layer neurons 10 in bursts. The input buffer 7 may be included in the input signal source 6, may be included in the spiking neural processor 1, may be implemented as a separate unit, or may be omitted if not needed.

In one embodiment the input buffer 7 and the storage unit 20 are controlled to coordinate their functions. For example, storage unit 20 may be controlled to record the memory-neuron output signals 26 during each burst period when the input buffer 7 forwards input signals 8 to the neurons 10. The storage unit 20 may be configured to record during the entire burst period or for a portion of the burst period, e.g. for a period at the end of the burst period. Furthermore, the storage unit 20 may be controlled to output the previously stored memory-neuron output signals 26 to the augmented inputs circuits 25 during each burst period when the input buffer 7 forwards input signals 8 to the neurons 10.

The operation of the spiking neural processor on FIG. 3 will now be described with reference to the example signal timelines shown in FIG. 4.

The first row of FIG. 4 is an example timeline 30 of output data generated by signal source 6. The output data 30 may for example be in the form of a sequence of analog values, digital values, or one or more spike train signals. If the signal source 6 generates analog or digital values, these are preferably converted to a spike train signal suitable for input to the SNP at some point during processing of the SNP input signals. For example, analog or digital values may be converted into a plurality of spike train signals, where each spike train signal represents a certain range of values, and a spike is generated in one of the spike train signals when the analog or digital value falls within the range of the values for that spike train signal. The following description assumes the output data 30 is in the form of spikes for simplicity, although the conversion to spikes may be performed at a later stage in the system.

The output data (e.g. spikes) from the signal source 6 may occur in rapid bursts with a relatively long time period, e.g. 1 ms, between the bursts. However, there may be long time periods between each of the spikes, or the spikes may occur intermittently with long time periods between some of them, or the spikes may occur in bursts but with relatively long time periods between the spikes during the bursts.

An input buffer 7 may be used to accumulate the output data 30 from signal source 6 to generate rapid bursts of spikes at regular periodic intervals, separated by a long period between bursts. The input buffer 7 accumulates the output data 30 during a buffering period 34, e.g. 20 ms, and outputs the accumulated output data in a short burst period 35 at regular intervals. The buffering period 34 and burst period 35 may be selected based on the SNP design and the inference application to be performed by the SNP. For example, in a memory constrained system (for example an SNP implemented as an embedded system operating on only kilobytes of system memory for the input buffer 7 and memory 21), the maximum expected number of spikes per burst may be set to a smaller number to reduce memory requirements, leading to a lower buffering period 34 and burst period 35. However, the expected number of spikes per burst cannot be made an arbitrarily small number as a sufficient number of spikes are needed for the neurons to show a minimum level of activity (which will be stored for input to the augmented input circuits).

The second row of FIG. 4 is an example timeline 31 of the output from input buffer 7, which forms the input signals 8 to the spiking neural processor. During the burst period 35, the accumulated data stored during the buffering period 34 is transmitted to the input neurons 10. If the raw signal is not in the form of a spike train signal, the output from the input buffer 7 may be converted into a spike train signal. The burst period 35 may be set to a predetermined time period, which may be configurable, as described above. Following the burst period 35, the input buffer 7 ceases to output data during period 36 until the next burst period, while data is buffered for the next input signal burst.

During the input signal burst 40A, the input buffer 7 outputs the accumulated data as input signals 8 to the input neurons 10. The input neurons 10 generate neuron output signals 14 that are passed via synapses 17 to hidden neurons 11, which generate neuron output signals 15 that are passed via synapses 18 to output neurons 12, which generate neuron output signals 16 (SNP output 9).

The third row of FIG. 4 is an example timeline 32 of the spiking neuron outputs generated by the selected memory-neurons in the SNP, which are recorded in storage unit 20. The memory-neuron outputs 41A are recorded by storage unit 20 during the period of burst 40A of the input signals 8. The storage unit 20 stores data indicative of the received memory-neuron output signals 26 during this period.

The fourth row of FIG. 4 is an example timeline 33 of the output from storage unit 20, which becomes the input to the augmented input circuits 25. During burst 40A of the input signals 8, and the recording of the memory-neuron output signals 41A, there is no output from storage unit 20 and no input to the augmented input circuits 25. The next burst 40B of the input signals 8 occurs after another buffering period as shown in timeline 31. This results in memory-neuron output signals 41B, shown in timeline 32. During input signal burst 40B, the storage unit 20 outputs stored data 42A of the memory-neuron output signals 41A recorded during the earlier input signal burst 40A. As shown in timeline 33, the stored data is output 42A from the storage unit 20 after a predetermined delay 37 following recording of the memory-neuron output signals 41A generated during the earlier input signal burst 40A. Similarly, during the next input signal burst 40C, the storage unit 20 outputs stored data 42B of the memory-neuron output signals 41B recorded during the earlier input signal burst 40B.

In the example shown in FIG. 4, the output of stored data from storage unit 20 is timed to coincide with the next input signal burst (e.g. stored data output 42A coincides with input signal burst 40B). However, storage unit 20 could be instead configured to output the stored data at a different timing, for example during a time period just before the next input signal burst (e.g. output 42A may be output from storage unit 20 just before the input signal burst 40B). This configuration may be used to at least in part recreate the neural network state existing at the end of input signal burst 40A just before further input signals are received during input signal burst 40B.

Training the spiking neural network of the SNP may be accomplished using labelled data which is fed to the SNP in bursts. The augmented input circuits 25 are configured and memory-neurons are identified prior to the training. The training data is divided into smaller data sets (corresponding to the input signal bursts) and artificial delays are inserted between the data sets so that the training mimics the inference environment (the SNN is mostly trained to work on a particular set of data in a particular environment). During training, the SNN learns the presynaptic weights for both the normal input neurons 10 as well as the augmented input circuits 25. This is accomplished through training the network by feeding it with the training data sets and the network “learns” the weights in the process of training.

A simulated benchmark test was performed on an SNN using the data storage and feedback method described herein. The publicly available Spiking Heidelberg Digits (an audio-based classification dataset of spoken digits zero to nine converted into spike trains) for empirically examining the efficacy of this technique. The dataset with 100 spike vectors was used to train a spiking neural network comprising 700 input neurons, 400 neurons in the second hidden layer, and 20 output neurons, using the surrogate gradient descent training technique. The training was performed with varying burst sizes, ranging from no bursts to 20, 10 and 8 spikes per burst. The memory capacity (for the input signal buffer and memory-neuron storage unit) required for each burst size is estimated in the table below, the memory capacity measured in number of spikes to be stored.

| Burst Size (no. of | No. of input | No. of stored | Total memory |
|---|---|---|---|
| spikes) | spikes/burst | spikes/burst | capacity (spikes) |
| Original (no bursts) | 70000 | N/A | 70000 |
| Burst Size = 20 | 14000 | 8000 | 22000 |
| Burst Size = 10 | 7000 | 4000 | 11000 |
| Burst Size = 8 | 5600 | 3200 | 8800 |

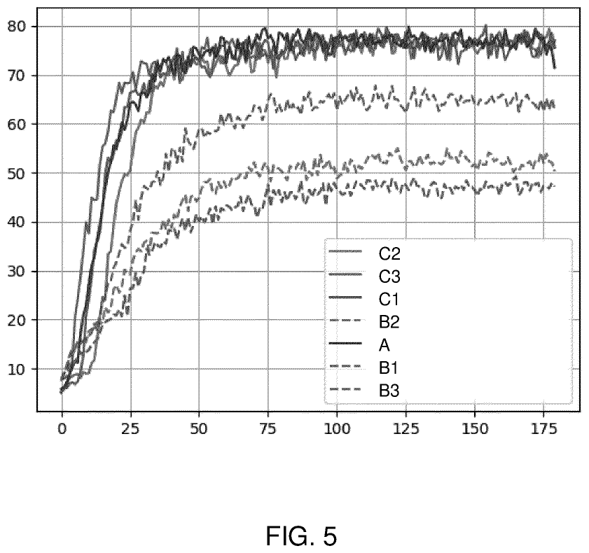

FIG. 5 shows a performance profile of the spiking neural network derived from the test. The horizontal axis indicates the number of training epochs, and the vertical axis indicates an estimate of the performance of the network, based on the accuracy of inference. The solid blue line A indicates performance when the data (the Spiking Heidelberg Digits) was input to the SNN without subdividing into bursts, requiring a large amount of memory. The dashed lines B1, B2, B3 indicate network performance for bursts of 8, 10 and 20 spikes per burst respectively, but with no feedback of recorded memory-neuron data. The solid lines C1, C2, C3 indicate network performance for bursts of 8, 10 and 20 spikes per burst respectively, with feedback of recorded memory-neuron data to augmented input circuits.

The test indicates that network performance drops significantly when the dataset is received by the SNN in bursts, particularly small bursts (dashed lines). However, this drop in the performance is compensated for when feedback of the memory-neuron outputs to the augmented input circuits is provided (solid lines).

The systems and methods described herein are particularly useful resource (e.g. memory and data bandwidth) constrained systems such as embedded systems, that require storing large amounts of data from a slow or intermittent sensor or other signal source, for processing in a fast neuromorphic system. The systems and methods described herein greatly reduce the amount of memory required for storing the input signal data, and also reduce the loss of accuracy since the SNN may be allowed to “forget” temporal network state information between sensor samples, and is assisted to “remember” the lost information by feeding it a snapshot of the previous neural network state.

1. A spiking neural processor configured to receive one or more input signals and generate one or more inference output signals, the spiking neural processor comprising:
a plurality of neurons interconnected by a plurality of synaptic elements to form a spiking neural network, wherein a portion of the neurons are connected to receive the one or more input signals and each of the neurons is configured to generate a neuron output signal;
a storage unit connected to receive one or more of the neuron output signals from a selected subset of the neurons; and
one or more augmented input circuits connected by the synaptic elements to selected ones of the neurons of the spiking neural network;
wherein the storage unit is configured to store data indicative of the received neuron output signals, and output at least a portion of the stored data after a predetermined delay; and
wherein the augmented input circuits are connected to receive the stored data outputted by the storage unit after the predetermined delay.

2. The spiking neural processor of claim 1, wherein the storage unit is configured to store the data indicative of the received neuron output signals during a period when the input signals are received by the spiking neural network, and configured to not store the data during a period when no input signals are received by the spiking neural network.

3. The spiking neural processor of claim 1, wherein the storage unit is configured to output at least a portion the stored data during a subsequent period when the input signals are received by the spiking neural network, and configured to not output the stored data during a period when no input signals are received by the spiking neural network.

4. The spiking neural processor of claim 3, wherein the data outputted by the storage unit during the subsequent period comprises at least a portion the data stored during an immediately preceding period when the input signals were received by the spiking neural network.

5. The spiking neural processor of claim 1, wherein the storage unit is configured to store data encoding a spike time, a spike amplitude, and/or a spiking rate of the neuron output signals from the selected subset of the neurons.

6. The spiking neural processor of claim 1, wherein the operation of the storage unit is coordinated with an input buffer circuit, so that the storage unit records the data indicative of the received neuron output signals during a burst period when the input buffer circuit forwards the input signals to the spiking neural network, and does not record the data during a period when the input buffer does not forward the input signals to the spiking neural network.

7. The spiking neural processor of claim 1, further comprising an input buffer circuit connected to receive one or more signals from an input signal source, wherein the input buffer circuit is configured to accumulate the received signals for a buffering period and output the accumulated signals during a burst period as the input signals to the spiking neural network.

8. The spiking neural processor of claim 7, wherein the buffering period of the input buffer circuit is coordinated with the predetermined delay of the storage unit.

9. The spiking neural processor of claim 7, wherein the storage unit is configured to output the stored data during a period when the input buffer circuit outputs the accumulated signals to the spiking neural network.

10. The spiking neural processor of claim 7, wherein the burst period is at least 10 times shorter than the buffering period, the input buffer circuit being configured to output the accumulated signals at a compressed time scale in comparison to the signals received from the input signal source.

11. A method of operating a spiking neural processor configured to receive one or more input signals and generate one or more inference output signals, the spiking neural processor comprising a plurality of neurons interconnected by a plurality of synaptic elements to form a spiking neural network, each of the neurons is configured to generate a neuron output signal, the method comprising:
connecting one or more augmented input circuits by the synaptic elements to selected ones of the neurons of the spiking neural network;
receiving the one or more input signals by a portion of the neurons;
receiving one or more of the neuron output signals from a selected subset of the neurons by a storage unit;
storing data indicative of the received neuron output signals in the storage unit; and
outputting from the storage unit at least a portion of the stored data after a predetermined delay; and
receiving by the augmented input circuits the stored data outputted by the storage unit after the predetermined delay.

12. The method of claim 11, wherein the storing of the data indicative of the received neuron output signals is performed during a period when the input signals are received by the spiking neural network.

13. The method of claim 11, wherein the outputting from the storage unit of at least a portion of the stored data is performed during a subsequent period when the input signals are received by the spiking neural network.

14. The method of claim 11, further comprising coordinating the operation of the storage unit with an input buffer circuit, so that the storage unit stores the data indicative of the received neuron output signals during a burst period when the input buffer circuit forwards the input signals to the spiking neural network, and does not record the data during a period when the input buffer does not forward the input signals to the spiking neural network.

15. The method of claim 11, further comprising connecting an input buffer circuit to receive one or more signals from an input signal source, accumulating the received signals for a buffering period, and outputting the accumulated signals during a burst period as the input signals to the spiking neural network.
